(19) United States
(12) Patent Application Publication
(10) Pub. No.: US 2011/0080579 A1
(43) Pub. Date: Apr. 7, 2011

(54) Chemical sensor employing resonator-enhanced forbidden-light collection

(76) Inventor: Andrew C.R. Pipino, Pasadena, CA (US)

(21) Appl. No.: 12/587,268

(22) Filed: Oct. 5, 2009

(51) Int. Cl. G01J 3/44

(52) U.S. Cl. 356/301

(57) ABSTRACT

A chemical sensor that includes, in one example embodiment, a dielectric resonator, wherein a material sample to be characterized is positioned a species to be detected, wherein the species is positioned near a surface of the resonator so that evanescent electromagnetic energy emanating from the surface causes Raman scattering from the species. The resonator is adapted to support modes propagating within the resonator, wherein the modes are adapted to yield the evanescent electromagnetic energy and to couple Raman-scattered electromagnetic energy back into one or more of the modes. In a more specific embodiment, the dielectric cavity represents a stable optical resonator. An input coupling optic couples input electromagnetic energy into the dielectric cavity via photon tunneling across a gap between the input coupling optic and the dielectric cavity. A distance across the gap is approximately one wavelength or larger, wherein the wavelength corresponds to a wavelength of the input electromagnetic energy. An output coupling optic is adapted to couple one or more modes within the dielectric cavity that contain electromagnetic energy corresponding to the Raman-scattered electromagnetic energy, and to provide an output signal in response thereto.

### BACKGROUND OF THE INVENTION

1. Field of Invention

This invention relates to chemical sensors. Specifically, the present invention relates to spectroscopic chemical sensors employing Raman scattering.

2. Description of the Related Art

Chemical sensors are employed in various demanding applications including industrial process monitoring, environmental monitoring, national security (e.g., chemical weapons detection), defense (e.g., munitions-condition monitoring), medical diagnostics (e.g., disease characterization), drug delivery monitoring, biosensing (e.g., virus detection), industrial process control, product quality monitoring, and scientific research, and so on. Such applications often demand compact, versatile, selective, highly sensitive chemical detectors.

For the purposes of the present discussion, a chemical sensor, also called a chemical detector, may be any device that is adapted to facilitate characterizing a substance, such as by detecting existence of a chemical, concentration of a chemical, or material composition of the substance, also called the species or the analyte. An example chemical detector senses or otherwise determines the presence or the likelihood of the presence of a given substance within a material sample.

Chemical detectors often employ spectroscopic methods, such as Raman spectroscopy, that exploit unique spectral fingerprints that characterize the interaction of a given molecule with different regions of the electromagnetic spectrum. In certain chemical detectors employing Raman spectroscopy, a species to be analyzed is illuminated with laser energy, which inelastically scatters (i.e., Raman-scatters) the laser energy. The scattered energy is then analyzed for chemical signatures. For the purposes of the present discussion, Raman scattering may be any inelastic scattering of electromagnetic energy.

Raman-scattered photons typically indicate changes in vibrational, rotational, or electronic energy of a molecule. In cases where the given molecule absorbs energy, the Raman scattering is called Stokes scattering. In cases where the given molecule loses energy, the scattering is called anti-Stokes scattering. The resulting Raman-scattered photons may be analyzed to determine, for example, the existence or concentration of a certain chemical in a given sample.

Scattered energy from a given sample may include significant elastic Raleigh scattering, which is often filtered to facilitate analysis of the weaker Raman-scattered energy. Unfortunately, the resulting Raman signal often remains too weak for very sensitive chemical detection.

To enhance Raman scattering to facilitate chemical detection, Surface Enhanced Raman Spectroscopy (SERS) is often employed. An example SERS detector employs a strategically textured metal surface, such as gold or silver, onto which a chemical sample has been disposed or absorbed. Enhancements in the Raman-scattered energy may result from interaction between localized surface plasmons in the textured metal with both incident laser energy and the resulting Raman-scattered energy from the sample molecules.

Incident laser energy is thought to excite surface plasmons about a given chemical sample, which amplifies the surrounding electric field, including the field corresponding to incident laser energy and the resulting Raman-scattered energy. The frequency of the incident laser energy may be tuned to resonate with the plasmon frequency for maximum enhancement.

Field enhancement is thought to occur twice in a SERS device. Initially, the incident electromagnetic energy is thought to be amplified by the plasmons. The amplified incident field then excites Raman scattering by the sample molecules, thereby increasing the Raman-scattering energy, called the Raman signal. The Raman signal is further amplified by the plasmon oscillations, just as occurs at the incident frequency. The total resulting electric field corresponding to the total Raman signal is thought to be enhanced by approximately a total power of four ((E²*E²=E⁴), which is an approximation to the product of the field enhancement at the incident and Raman-scattered frequencies.

Unfortunately, metal surfaces required for plasmon-based enhancement of Raman signals can be susceptible to heating and resulting reduced Quality factor (Q). Furthermore, nano structures used to texture a metal surface may be susceptible to damage or degradation, which can degrade the Raman signal. In addition, certain molecules may exhibit unknown electronic resonance when in proximity to such metal surfaces, which can complicate accurate chemical detection and selectivity, such as by resulting in detection errors. Furthermore, construction of the metal surfaces and accompanying nano structures may be cost-prohibitive for certain applications, and such devices may be difficult to accurately reproduce. In addition, SERS chemical detectors may not be suitable for applications where the species cannot be effectively bound to the metal surfaces thereof. Such factors can limit mass fabrication and commercial viability of SERS devices for sensitive and selective chemical detection.

Hence, a need exists in the art for a versatile, compact, cost-effective, highly sensitive and selective chemical sensor that provides reproducible response and can be mass-fabricated.

### SUMMARY OF THE INVENTION

The need in the art is addressed by a chemical sensor that includes, in an example embodiment, a dielectric resonator. A source of coherent electromagnetic energy, such as laser energy, is coupled to the dielectric resonator so that one or more modes of electromagnetic energy propagate within the dielectric resonator. The propagating modes yield an evanescent field near boundaries of the dielectric resonator. A species to be analyzed is positioned near the boundaries to enable the evanescent field to cause scattering of electromagnetic energy from the species and to enable coupling of resulting scattered electromagnetic energy to one or more modes propagating within the dielectric resonator.

In a more specific embodiment, the scattered electromagnetic energy includes Raman-scattered electromagnetic energy. The species is positioned relative to a sidewall of the dielectric resonator to enable double resonance. The Raman-scattered electromagnetic energy results from evanescent electromagnetic energy incident upon the species in the form of an evanescent wave. The resulting Raman-scattered electromagnetic energy, also called the Raman signal, is coupled back in to the dielectric resonator via the one or more modes propagating within the dielectric resonator.

Optical modes propagating within the dielectric resonator are substantially confined by total internal reflection by one or more sidewalls of the dielectric resonator. The dielectric resonator is dimensioned to ensure that a plurality of modes propagate within the dielectric resonator. Plural modes are chosen to increase the probability that the Raman signal will couple to one or more of the plural modes propagating within the dielectric resonator. The plural modes are said to optimize a photon density of states to maximize coupling of Raman-scattered electromagnetic energy to modes propagating within the dielectric resonator.

The dielectric resonator represents a stable high-Q (or high finesse) cavity with narrow cavity modes. An input coupling optic is positioned near a first sidewall of the dielectric resonator so that an evanescent field emanating from the input coupling optic couples into the cavity resonator via photon tunneling. The coupling optic may include a fiber optic waveguide, prism, or other suitable optic.

The coupling optic is spaced relative to the first sidewall to create a gap therebetween. The gap width satisfies or approximately satisfies an impedance-matched condition such that energy loss associated with a group of photons tunneling across the gap approximately equals the energy loss associated with the group of photons experiencing a round-trip traversal of the dielectric resonator. The gap width is approximately a wavelength of the electromagnetic energy or larger. Resonator Q-factor or finesse may be tuned by adjusting the gap width.

The novel design of certain embodiments discussed herein is facilitated by use of a stable dielectric resonator to provide well-defined, high-Q optical modes, which can be efficiently excited by an appropriate light source.

The novel design of certain embodiments discussed herein is further facilitated by use of a dielectric resonator (e.g., silica or glass) that sustains optical modes by total-internal reflection, such that the near field energy, also called evanescent waves or forbidden light, can be used for chemical sensing. The benefits of the evanescent wave are multi-fold. Specifically, for double resonance enhancement of Raman-scattered electromagnetic energy, the incident near field energy on a species yields a Raman signal that is resonant with one or more modes within the resonator. The resonator thereby acts to efficiently collect the Raman-scattered light. Coupling between the Raman emission and the modes of the resonator facilitates converting near field Raman-scattered energy into far field energy propagating within the resonator. The resulting Raman-scattered energy within the resonator may be extracted and analyzed to facilitate characterization of the species, i.e., material sample. Use of Raman spectroscopy as disclosed herein can reveal small changes in chemical composition of complex mixtures through subtle spectral variations.

A dielectric resonance structure as disclosed herein enables significant Raman signal enhancements, which may be larger than enhancements achieved via conventional metallic SERS structures. Such significant Raman signal enhancement is due in part to the very high-Q resonator modes enabled by smaller optical losses in the accompanying dielectric resonator as compared to metal SERS devices. In addition, use of dielectric materials will facilitate cost-effective mass production and improve reproducibility in comparison with conventional SERS-based chemical detectors.

Certain embodiments disclosed herein may obtain Raman vibrational spectra via a fixed wavelength, narrow bandwidth, and low-power diode laser source such as an extended cavity diode laser. This may further facilitate construction of compact devices, since large high-power tunable laser sources may be unnecessary.

Furthermore, a well-established database associating Raman spectra with chemical information may be used to facilitate species characterizations. Existing signal processing and pattern-recognition algorithms may also be leveraged to facilitate analyzing Raman spectra obtained via one or more embodiments disclosed herein.

Certain embodiments disclosed herein represent a new class of chemical sensors that circumvent the limitations of conventional SERS devices by achieving large Raman signal enhancements without the problematic use of the Surface Plasmon Resonance (SPR) or accompanying metal surfaces textured with fragile nanoparticles.

### BRIEF DESCRIPTION OF THE DRAWINGS

FIG. 1 is a diagram of a chemical sensing system according to a first example embodiment.

FIG. 2 is a diagram of a chemical sensor according to a second example embodiment.

FIG. 3 is a diagram of an alternative chemical sensor according to a third example embodiment.

FIG. 4 is a diagram of an array of chemical sensors according to a fourth example embodiment.

FIG. 5 is a flow diagram of a method adapted for use with the chemical sensors of FIGS. 1-4.

### DESCRIPTION OF THE INVENTION

While embodiments are described herein with reference to particular applications, it should be understood that the embodiments are not limited thereto. Those having ordinary skill in the art and access to the teachings provided herein will recognize additional modifications, applications, and embodiments within the scope thereof and additional fields in which the present invention would be of significant utility.

For clarity, various well-known components, such as power supplies, mounting systems, and so on, have been omitted from the figures. However, those skilled in the art with access to the present teachings will know which components to implement and how to implement them to meet the needs of a given application. Furthermore, the figures are not necessarily drawn to scale.

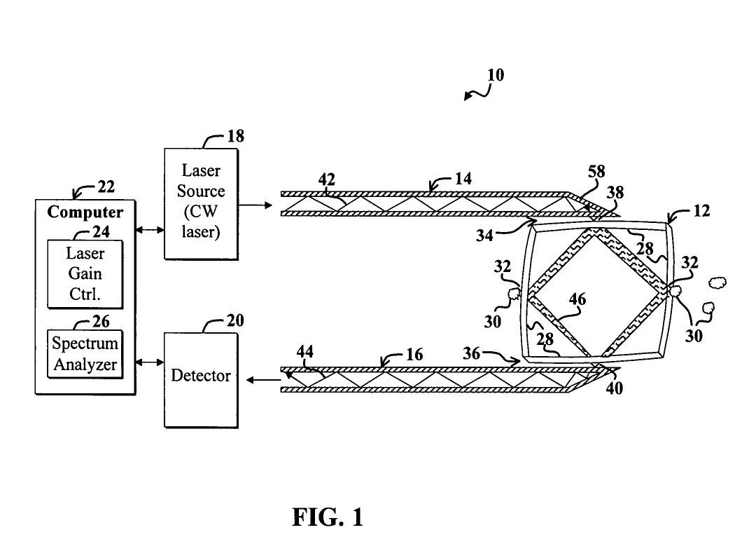

FIG. 1 is a diagram of a chemical sensing system 10 according to a first example embodiment. The example system 10 includes a stable dielectric resonator 12, which represents a cavity bounded by substantially reflective sidewalls 28. In the present embodiment, the resonator cavity has an approximately square cross-section with the exception that the interior surfaces 28 are slightly concave, i.e., curved inward. While only four interior surfaces 28 are shown, the resonator 12 may be surrounded by reflective surfaces on all sides.

For the purposes of the present discussion, a dielectric resonator may be any device with substantially reflective interior sidewalls adapted to at least partially confine electromagnetic energy, such as optical energy, in a space between the interior sidewalls, wherein one or more of the interior sidewalls include a dielectric, also called dielectric material. Optical energy may be any energy associated with photons and may be contained in electric and magnetic fields associated with the photons. An optical resonator may be any device with substantially reflective interior sidewalls adapted to at least partially confine optical energy.

Electromagnetic energy may be any energy associated with photons, plasmons, electrons, or other particles associated with oscillating electric and magnetic fields, and may be contained in electric and magnetic fields associated with the particles. A wavelength of electromagnetic energy represents a wavelength characterizing propagating or oscillating particles thereof.

A dielectric may be any non-metal insulator or other material that is substantially not electrically conductive at voltages less than the breakdown voltage of the dielectric. An example dielectric, which may be employed to construct the resonator 12, is silica.

A stable resonator may be any optical cavity with reflective internal sidewalls, where electromagnetic energy is refocused upon each traversal of the cavity. Stable resonators or cavities may have one or more curved interior surfaces, such that the radius of curvature of one or more of the interior surfaces is less than infinity. The interior of the resonator 12 is adapted to support one or more modes 46 of electromagnetic energy, as discussed more fully below.

The modes of an optical cavity or resonator correspond to a discrete set of frequencies or wavelengths of electromagnetic energy that are supported by the resonator. The resonator 12 suppresses the remaining frequencies. The modes 46 represent the frequencies of electromagnetic energy, e.g., light, which are substantially self-regenerating within the resonator 12 and allowed to oscillate within the resonator 12. Other frequencies of electromagnetic energy are suppressed within the resonator 12 by destructive interference. Each mode 46 may have a linewidth or narrow range of frequencies about the center frequency of the mode 46. The linewidth is affected by the finesse of the resonator 12 and is typically smaller than the inter-mode frequency separation or Free Spectral Range (FSR).

The linewidth may be characterized by the full-width at half maximum intensity (FWHM). The FWHM of a beam or optical line corresponds to the distance between opposing positions on the beam or linewidth where the intensity is half of the maximum intensity of the beam or line. The maximum intensity often occurs near the center of the beam or line. The free spectral range (FSR) may be the wavelength separation between adjacent cavity modes. Resonator finesse is the ratio of the free spectral range to the linewidth of a mode corresponding to a specific cavity resonance wavelength.

Resonator quality factor (called Q or Q-factor) is the ratio of energy stored to the energy dissipated in the resonator mode volume per cycle. Both the Q-factor and resonator finesse are related to the FWHM of the resonator modes 46 and may be representative of the ability of a resonator 12 to confine the electromagnetic fields of the optical energy within the resonator 12. Relatively lossy resonators or devices are often characterized by relatively low Q-factor and finesse. The resonator finesse and Q-factor are inversely proportional to the linewidth of an optical mode and are inversely proportional to the optical loss per-pass for light propagation through the resonator 12.

Hence, an optical resonator (also termed optical cavity or etalon) may confine electromagnetic radiation through highly reflective boundaries, which permit localized build-up of electromagnetic energy. The specific frequency bands over which energy is allowed to build-up represent resonator modes.

The energy build-up within resonator modes can be exploited, as discussed herein, to enhance spectroscopic detection of chemical species located within the resonator mode volume. The mode volume of the resonator 12 may include the physical space within which the energy build-up occurs and may further include the space beyond interior surfaces 28 that exhibits evanescent fields.

Hence, a low-loss optical resonator, such as the resonator 12, may support optical modes having relatively sharp linewidth. The resonator 12 may also be characterized by a spectral bandwidth, which is the frequency range over which the resonator 12 maintains high finesse for its individual modes. The resonator spectral bandwidth may be determined by the reflectivity bandwidth of its constituent boundaries, although internal material losses may also be contributory.

Within spectral bandwidth of a high-finesse resonator, such as the resonator 12, and within the mode linewidth of an optical mode, the density of allowed radiative channels, corresponding to the photon density of states, may be greatly enhanced, as discussed more fully below. The photon density of states may affect the efficiency of excitation and emission processes. Certain example chemical sensors discussed herein may employ resonators that explicitly and simultaneously optimize both the efficiency of excitation and emission processes through judicious manipulation of the photon density of states to realize a new class of chemical sensors.

The chemical sensing system 10 further includes an input coupling optic 14 and an output coupling optic 16, which are optical waveguides in the present example embodiment. For the purposes of the present discussion, a coupling optic may be any device adapted to facilitate transferring electromagnetic energy from one device to another or across an interface between components of a device.

The input optical waveguide 14 is spaced relative to the interior surface 28 of the cavity by a predetermined input gap width 34. Similarly, the output optical waveguide 14 is spaced relative to the interior surface 28 by an output gap width 36. The gap widths 34, 36 are chosen to meet impedance-matched conditions and to enable photon tunneling across the gap widths 34, 36, as discussed more fully below.

The input optical waveguide 14 is fed by a laser beam 42 from a laser source 18, which is optionally coupled to a controller 22, which might include a laser gain-control algorithm 24. Output electromagnetic energy 44 from the output optical waveguide 16 is input to an optical detector 20, which may include a dispersive element such as a grating or prism. The detector 20 may include a Charge-Coupled Device, which may be an array of detectors that are responsive to frequencies within the output electromagnetic energy 44. The detector 20 is coupled to computer or other data analysis vehicle 22, which includes, by way of example, a spectrum analyzer 26. The spectrum analyzer 26 may include functionality, including a database and a user interface, to facilitate analyzing the output electromagnetic energy 44 to facilitate characterization of material samples, i.e., species 30 positioned in proximity to the surfaces 28 of the resonator 12.

In operation, the laser source 18 outputs coherent electromagnetic energy, such as laser light 42. The laser light 42 represents a coherent, monochromatic, Continuous Wave (CW) beam with substantially uniform polarization. The laser source 18 may be a helium-neon laser, or other laser, such as a low-power extended cavity diode laser with an operating wavelength between 600 and 900 nanometers. The exact laser used and its operating wavelength or range of operating wavelengths is application specific and may be readily determined by those skilled in the art with access to the present teachings to meet the needs of a given application. If the resonator 12 is made from silica, a suitable laser operating wavelength may be between 400 to 1500 nanometers.

The input laser light 42 propagates within the input optical waveguide 14, which confines the laser light 42 via Total Internal Reflection (TIR). The input optical waveguide 14 may terminate at a tapered end 58, although other designs may be appropriate and will be recognized by those skilled in the art. The laser light 42 creates an input evanescent field 38 near the internal reflective surfaces of the input optical waveguide 14.

For the purposes of the present discussion, an evanescent field may be any electric and/or magnetic field arising from evanescent electromagnetic energy. Evanescent electromagnetic energy may be any energy existing in or represented by an evanescent wave. An evanescent wave may be any near field wave with an intensity that exhibits exponential decay with distance from a boundary at which the wave was formed. Evanescent waves often form at a boundary between two media with different refractive properties. Evanescent waves and corresponding fields are often most intense within one-third of a wavelength from the boundary or surface from which the evanescent waves emanate. Evanescent waves often form on an opposite side of a surface when incident waves travelling in a medium undergo total internal reflection at the surface of the medium, where the waves are incident on the surface at an angle near or greater than the critical angle of incidence.

The input gap width 34 is chosen to enable electromagnetic energy in the input evanescent field 38 to couple into the resonator 12, yielding the propagating resonator modes 46. The gap width 34 is chosen to meet an impedance-matched condition, which is met when energy loss associated with a group of photons tunneling across the gap 34 approximately equals the energy loss associated with a round-trip traversal by the group of photons about the dielectric resonator 12. The coupling loss across the gap width 34 is said to equal the sum of all round-trip signal losses within the resonator 12 when the gap width 34 is impedance matched.

In the present example, a narrowband laser source 18 is employed, and the input gap width 34 is on the order of a wavelength or larger. The exact gap width 34 may be application specific and may be readily determined by those skilled in the art to meet the needs of a given implementation. Generally, the less lossy the resonator 12, the larger the gap width 34 will be for impedance-matched conditions to the extent that the coupling loss across the gap width 34 decreases as the gap width 34 increases.

The overall finesse of the resonator 12 may be adjusted by varying the gap width 34. For example, increasing the gap width 34 may enhance resonator finesse. When the gap width 34 reaches or exceeds impedance-matched conditions, the resonator finesse is approximately maximized. Lower resonator finesse may be obtained by reducing the gap width 34 to below the width of the impedance-matched gap width.

The input evanescent field 38 supports a photon tunneling process, whereby photons tunnel across the input gap width 34. For the purposes of the present discussion, photon tunneling may be any process wherein a photon traverses a space between a first medium or device and a second medium or device. A specific example of photon tunneling includes wave-mechanical tunneling, which is a type of evanescent-wave coupling characterized by the evanescent-wave solutions of the Schrodinger wave equation. Photons transiting the gap width 34 via the evanescent field 38 may undergo wave-mechanical tunneling or other types of tunneling.

Electromagnetic energy coupled into the resonator 12 via input evanescent field 38 results in modes 46 propagating within the resonator 12. In the present example embodiment, the resonator 12 is larger than approximately 1 millimeter by 1 millimeter, which is larger than approximately 1000 times the wavelength of the operating center frequency of the laser light 42. This relatively large size facilitates enabling the resonator 12 to support a high density of modes, wherein each mode is characterized by a narrow linewidth. The dimensions are chosen to modify the mode density within the resonator 12 so that the Raman spectrum of the analyte species 30 is accurately represented in the output beam 44. More specifically, the Raman spectrum may be represented by a discrete array of numbers, where each number is generated from the output from a single resonator mode, all of which are combined in beam 44 and ultimately separated and detected via the detector 20. The resonator 12 is said to be characterized by a “modified photon density of states” from the perspective of the emitting analyte 30, compared to emission in free space. Exact resonator dimensions are application specific and may readily be determined by those skilled in the art with access to the present teachings to meet the needs of a given application.

For the purposes of the present discussion, the term “photon density of states” may refer to the density of electromagnetic modes in the volume of the resonator 12, i.e., the optical cavity, which corresponds to the number of electromagnetic modes in a unit volume of the resonator 12 within a predetermined frequency interval. The photon density of states affects the probability of spontaneous photon emission/scattering by a species, such as the species 30 for a given frequency.

The plural modes 46 are chosen to increase the probability that the Raman signal from the evanescent waves 32 will couple to one or more of the plural modes 46 propagating within the dielectric resonator 12. The modes 46 are said to optimize a photon density of states to maximize coupling of Raman-scattered electromagnetic energy to modes 46 propagating within the dielectric resonator 12. The modes 46 may be selectively altered by adjusting dimensions of the resonator 12; adjusting the wavelength of the laser source 18, and so on. Those skilled in the art with access to the present teachings may readily modify the sensor 10 to enable the resonator 12 to support appropriate modes for a given application, without undue experimentation.

The modes 46 propagating within the resonator 12 are substantially confined within the resonator 12 via total internal reflection, which results in exterior evanescent fields 32, which act as probing fields of surrounding medium. The material samples, i.e., species 30 to be analyzed are positioned within the exterior evanescent fields 32. The exterior evanescent fields 32 induce Raman scattering from the species 30, and the resulting Raman-scattered energy couples back into one or more of the resonator modes 46. The resonator modes 46, including the evanescent waves 32, initially induce Raman scattering that resonates with the emitted Raman light and amplifies a Raman-scattered signal through the presence of resonator modal fields 46 at both the incident and scattered frequencies. This process represents a double-resonance process.

Both the excitation and collection of Raman-scattered energy is especially efficient, as the Raman differential cross-section of a molecule of the species 30 in the evanescent mode volume is modified by the resonator boundary conditions. In particular, the molecule (i.e., the species 30) preferentially scatters light into directions having the highest density of radiative channels (i.e., the highest photon density of states), which correspond to resonator modes. Coupling of the Raman-scattered energy may be affected by design parameters including: 1) the effective angle of incidence of the circulating mode, 2) the critical angle of the resonator-ambient medium interface (corresponding to the surface 28), 3) the resonator dimensions, and 4) the orientation of the molecule of the species 30 that is being probed. One condition for especially efficient excitation and collection of scattered light at the resonator-ambient medium interface holds when the effective angle of incidence of the circulating mode is close to the critical angle of the resonator-ambient medium interface (corresponding to the surface 28). Moreover, efficient collection and excitation tend to occur under the same conditions of incident angle, species orientation, resonator mode dimensions, etc. based on the principle of optical reciprocity. While the principle of optical reciprocity holds rigorously for identical incident and scattered frequencies, it also holds well for the moderate frequency shifts between the incident and scattered frequencies that are encountered in Raman spectra. Also by optical reciprocity, the Raman-scattered light that is collected in resonator modes is coupled back out into the output optical waveguide 16, where it can be conveniently transported for detection.

Molecules of the species 30 present in the evanescent wave region, or more generally in the resonator mode volume, will also be subjected to the circulating Raman-scattered light that builds up in the resonator 12. Consequently, Raman scattering will be further stimulated, as the rate of normal Raman scattering is proportional to N_{L}(ω)*(N_{R}(ω)+1), where N_{L}(ω) and N_{R}(ω) correspond to the number of photons present at the molecule (i.e., species 30) at the laser and Raman-scattered frequencies, respectively.

For the purposes of the present discussion, Raman-scattered energy may be any energy that has been scattered by a Raman scattering process, any inelastic scattering process, or any two-photon process.

An example of a double resonance process occurs when the optical energy in one mode induces emission that is in-resonance with another mode. Hence, a double resonance process inherently implies the presence of two coupled processes. Moreover, both excitation and emission processes can take place in the evanescent regions associated with optical modes that are confined by TIR.

Note that while an external laser source is employed in example embodiments discussed herein, the invention is not limited thereto. Furthermore, although both an input optical waveguide 14 and an output optical waveguide 16 are shown, embodiments where an optical fiber or a simple prism is employed to both feed the resonator 46 and to retrieve and analyze resulting Raman spectra may be employed. Moreover, a single waveguide, optical fiber, or coupling prism could be employed instead of two such elements.

Use of near field, i.e., evanescent electromagnetic energy to induce Raman scattering from a species may result in a corresponding evanescent field corresponding to the Raman-scattered signal. This Raman evanescent field is then converted to the far field when it couples to the cavity modes 46. The cavity modes 46 may represent a comb-like structure over a predetermined frequency range, where each prong of the comb corresponds to a mode propagating within the resonator 12. Various prongs of the comb may collect different components of the resulting Raman-scattered signal from the species 30.

For the purposes of the present discussion, a species is said to be characterized if information about one or more material properties or chemical components of the species is transferred to a signal, such as an optical beam or mode propagating within a resonator.

The resonator 12 has high-finesse or high-Q, which facilitates enabling high mode density and provides large signal enhancement. High-Q implies sharp comb-like mode structure for the resonator. Moreover, the resonator dimensions are selected appropriately to provide a plurality of modes, wherein the wavelength separation between modes is more than twice as large as the FWHM of modes propagating within the cavity. A cavity is said to have narrow cavity modes if the linewidths associated with the cavity modes are more than twice as narrow as the wavelength or frequency spacing between intensity peaks of adjacent cavity modes. An intensity peak corresponds to the frequency at which a beam or mode reaches maximum electromagnetic field strength.

The resonator modes 46 collect Raman-scattered signals from the species 30 and resonate therewith. The resulting modes 46 yield output evanescent energy 40, which may photon-tunnel across the output gap 36 and couple into the output channel corresponding to the output optical waveguide 16. The output gap width 36 is impedance matched or nearly so, as is the input gap width 34. In the present embodiment, the output gap width 36 is approximately a wavelength or larger, where the wavelength corresponds to the operating center frequency of the input laser beam 42.

The resulting coupled output electromagnetic energy 44 is spread (dispersed) onto an array of optical detectors, such as represented by the detector 20, which converts the optical signals 44 into corresponding electrical signals. The resulting electrical signals may be analyzed by the spectrum analyzer 26 running on the computer 22. The spectrum analyzer 26 may include databases and other components and software as needed to facilitate characterizing the species 30 or material in which the species 30 are positioned.

Hence, the chemical sensor 10 represents a highly sensitive and selective chemical detector that exploits double-resonance Raman scattering by a species located within the mode volume of a miniature, high-finesse, stable, dielectric resonator 12. In particular, the mode volume includes the evanescent wave regions 32.

Intense, narrow-bandwidth optical radiation derived from excitation of a single resonator mode or a small group of modes 46 propagating within the resonator 12 serves as the Raman excitation source. Simultaneous optical resonance of both the excitation and Stokes or anti-Stokes shifted radiation leads to an overall quadratic dependence of the Raman signal on resonator finesse in accordance with the principle of optical reciprocity for the two-photon process. Significant Raman signal enhancements can thereby be achieved based on the high finesse of the resonator 12. Such enhancements potentially enable single-molecule detection.

The differential scattering cross-section of a molecule emitting Raman-scattered energy is substantially altered by the resonator boundaries (e.g., corresponding to the inner surfaces 28 of the resonator 12), thereby enabling convenient and efficient signal collection. The modified differential cross-section is manifested through the photon density-of-states, which is explicitly manipulated as discussed herein to provide large signal enhancement and efficient Raman-scattered light (electromagnetic energy) collection.

The optical modes 46 are confined by total-internal reflection. Raman excitation occurs in the concomitant resonator-enhanced evanescent wave 32 near the light-confining surface 28. The corresponding near-field emission (i.e., “forbidden light”) from the analyte 30 is collected by resonator modes 46 at Raman-shifted frequencies.

The critical dimension of the resonator 12 may be many wavelengths in size to facilitate providing a high density of optical modes over the high-finesse spectral bandwidth of the resonator (>100 nanometers) 12, which then facilitates adequate sampling of the Raman spectrum. To further enhance detection specificity, the exterior sides of the dielectric surfaces 28, which are adjacent to the species 30, may be chemically modified or functionalized with molecular-recognition agents. The exact choice of molecular-recognition agent and how the agents are bonded to surfaces of the resonator 12 are application specific. For example, in a virus-detection application, antibodies or other proteins that have an affinity to the desired virus particles may act as the molecular recognition agent.

Furthermore, the sensor 10 is adapted for cost-effective mass-fabrication. Although high-finesse dielectric resonators can be fabricated by many methods, CO₂ laser annealing may be combined with Micro Electro Mechanical Systems (MEMS) optical lithographic methods to create the high-finesse micro-resonator 12. The CO₂ wavelength is strongly absorbed by certain dielectrics, such as silica (SiO₂), which is a suitable material for creating high-finesse dielectric resonators based on its ultra-high transmission characteristics throughout the visible and near-infrared spectral regions. The absorbed CO₂ laser energy at 10.6 micrometers permits precisely controlled annealing of silica monoliths, which reduces surface roughness to enable very high finesse to be reached. Moreover, the annealing process may be used to introduce surface curvature to the TIR surfaces, e.g., the inner surfaces 28, which may be important for achieving a stable optical design.

Other non-MEMS fabrication methods may facilitate fabrication of millimeter-length-scale, high-finesse optical resonators from bulk silica, which can be derived from selected ultra-high purity stock material. Extremely high-finesse resonators may be realized and mass-produced by combining high-purity stock material with CO₂ laser or other annealing techniques.

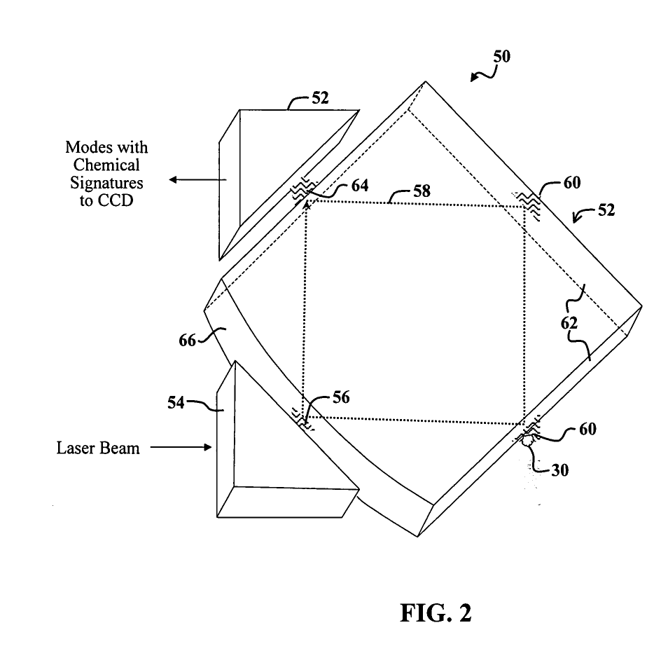

FIG. 2 is a diagram of a chemical sensor 50 according to a second example embodiment. The sensor 50 includes an alternative dielectric resonator 52, which is similar to the resonator 12 of FIG. 1 with the exception that the resonator 52 of FIG. 2 has one TIR reflective surface 66 that is concave (inwardly curved as viewed from the inside of the resonator 52), while the remaining reflective surfaces 62 are substantially planar. Furthermore, the input optical waveguide 14 is replaced by the input prism 54 in FIG. 2, and the output optical waveguide 16 is replaced by the output prism 52 in FIG. 2, although other optical devices may be used, such as optical waveguides of optical fibers.

In operation, a laser beam is input to a surface of the input prism 54, resulting in an input evanescent field 56, which couples photons into the resonator 52 via a gap between the input prism 54 and the curved resonator surface 66. The resulting electromagnetic energy 58 coupled into the resonator 52 via the input optic 54 propagates within the resonator 52, and is substantially confined by the surfaces 62, 66 via total internal reflection.

Evanescent fields form at various sensing spots 60 on the exterior surfaces of the resonator 52. Species 30 to be characterized may be positioned near the spots 60 so that evanescent fields thereof may induce Raman scattering from the species 30. The resulting Raman-scattered electromagnetic energy then couples back into one or more of the propagating modes 58. The resulting coupled modes 58 may then be sampled for further analysis by the output prism 52. The output prism 52 is positioned relative to a sidewall of the resonator 52 so that an output evanescent field 64 can couple with the output prism 52, yielding output that enables characterization of chemical signatures of any species positioned within the evanescent fields of the sensing spots 60. While only two sensing spots 60 are shown, other designs may provide many more sensing spots.

Like the resonator 12 of FIG. 1, the resonator 50 of FIG. 2 enables obtaining the vibrational spectrum of the species 30 with a single laser source by using a high mode-density resonator 52 to provide adequate sampling of the Raman spectrum to accurately represent the Raman spectrum of the species 30.

When a Raman signal couples to one of the modes 58, it may slightly shift the modes in frequency. The output signal from the output prism 52 may have a spectrum characterized by a comb-like structure with different modes. One tooth of the comb, i.e., one mode, may be excited by a laser beam to initiate Raman scattering, and the resulting Raman-scattered signal may be collected by other modes, i.e., other teeth of the comb. An accompanying spectrometer including a dispersive device and a CCD, such as may be included in the detector 20 of FIG. 1, may detect the various different frequency bands corresponding to the different modes.

The modes 58 of the resonator 52 of FIG. 2 and the modes 46 of the resonator 12 of FIG. 1 may be substantially astigmatic Gaussian modes. However, other resonator shapes may yield other types of modes without departing from the scope of the present teachings, as discussed more fully below.

Furthermore, note that using resonator modes to create near field energy, i.e., evanescent electromagnetic energy; then using the evanescent electromagnetic energy to initiate Raman scattering; and then using the resonator modes to resonate with and couple to the resulting Raman-scattered energy represents an efficient double-resonance process. This double-resonance process may facilitate significant Raman-scattered signal enhancements to facilitate characterizing chemical species.

The efficiency of coupling electromagnetic energy between the analyte species 30 and the resonator 52 via evanescent waves, in addition to the efficiency of excitation of Raman scattering by the evanescent wave and the efficiency of collection of said Raman scattering, may be maximized with respect to design parameters such as resonator geometry, size, material, etc. Moreover, the conditions that yield maximum Raman excitation efficiency and maximum collection efficiency of Raman-scattered energy may be related by optical reciprocity.

The resulting Raman-scattered energy from a species may exhibit a quadratic dependence upon the finesse of the resonator 52. Note that the effective finesse of the resonator 52 may be affected by adjusting the gap widths between the coupling optics, i.e., prisms 52, 54 and the resonator reflective surfaces 62, 64.

In summary, optical modes 58 within the cavity of the resonator 52 are confined by total internal reflection, thereby enabling Raman excitation of a species positioned in the resonator-enhanced evanescent wave 60 near the light-confining surface 62. The resulting Raman-scattered near-field signal, called forbidden light, is then collected by the resonator modes 58 at Raman-shifted frequencies, i.e., modes. Hence, the chemical sensor 50 samples a given Raman spectrum through a dense comb-like spectrum of high-finesse resonator modes. The Raman spectrum of a species is sampled at discrete, uniformly spaced frequencies, i.e., modes as opposed to one frequency.

By constructing the resonator 52 so that the modes 58 are incident on the surfaces 62, 66 at near the critical angle of incidence, evanescent energy from Raman-scattered signals may more readily couple into Raman-shifted modes 58 of the resonator 52.

Hence, the dielectric sensor 50 is a representative example of a new class of chemical sensors that circumvent the limitations of SERS by achieving large Raman signal enhancements without the use of Surface Plasmon Resonance (SPR) or a metal surface. The stable, high-finesse, dielectric optical resonator 52 is used to enhance both the incident and Raman-scattered fields.

A dielectric resonance structure, such as the resonator 52, can theoretically produce larger field enhancements than metallic SPR-based enhancing structures for the same angular resonance width. Furthermore, much sharper resonance widths can ultimately be achieved with dielectric structures due to the smaller optical losses incurred compared to metals.

Moreover, the chemical sensor 50 of FIG. 2, and the sensor 10 of FIG. 1 provide for the explicit manipulation and optimization of the excitation and emission photon density-of-states involved in the Raman scattering process, which is facilitated by the use of dielectric resonators 12, 52. In particular, the photon density of states for both excitation and emission channels is configured to be large and overlapping in direction and spectral range through judicious resonator design.

A synergistic design is thereby achieved, yielding large double-resonance signal enhancement and efficient light collection. In addition, note that the surface chemistry and electrodynamics of a dielectric are significantly different than a metal surface. This may eliminate the reproducibility problems associated with SERS-based sensors. Furthermore, the optical resonance enhancement mechanism discussed herein may be operative for all Raman-active chemical species.

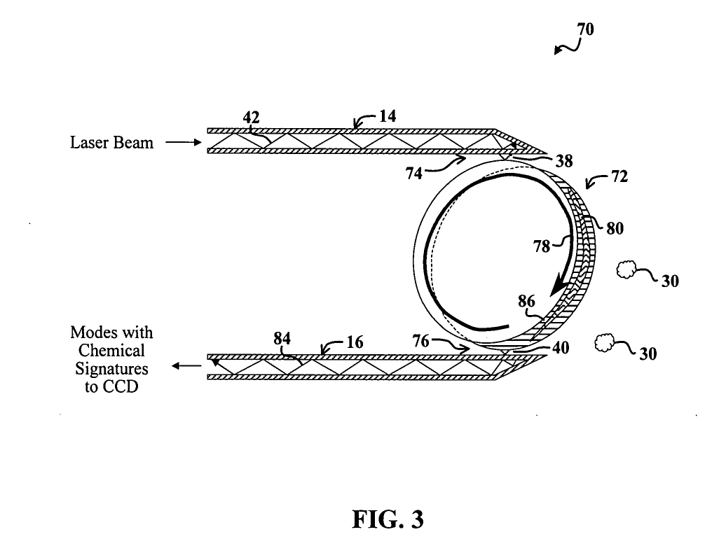

FIG. 3 is a diagram of a third example chemical sensor 70. The construction and operation of the third sensor 70 is similar to the construction and operation of the first chemical sensor 10 of FIG. 1 with the exception that the substantially cube-shaped dielectric resonator 12 of FIG. 1 is replaced with a disc-shaped resonator 72 in FIG. 3. The example disc-shaped resonator 72 is substantially radially symmetric, however, similar resonators with elliptical cross-sections may also be employed. In addition, spherical, toroidal, and other shaped resonators are anticipated. Furthermore, while the resonator 72 is solid (e.g., solid silica) in the present example embodiment, a cylindrical hollow resonator may be employed, and species may be positioned on the inner surface or the outer surface of the cylindrical resonator. Note that while the species 30 are shown as particles, the particles may be representative of molecules in a gas, liquid, solid, and/or a hybrid state, and the particles may be flowing or substantially stationary.

Input evanescent fields 38 couple across an impedance-matched input gap 74 between the input fiber optic 14 and the disc-shaped resonator 72. The input evanescent fields couple into modes 78 circulating within the resonator 72. The disc-shaped resonator 72 includes substantially reflective inner surface 86 and may be made from a low-loss dielectric material, such as silica.

The modes 78 supported by the resonator 72 include whispering gallery modes and modes satisfying the radial wave equation. One or perhaps a small group of modes is excited was an appropriate light source such as an extended cavity diode laser. A Raman-scattered signal from one or more of the species 30 in the evanescent wave couples back into the modes 78 at slightly shifted frequencies based on the Raman-scattering events. The frequency shifts may be toward higher or lower frequencies depending upon whether the Raman scattering is anti-Stokes or Stokes scattering, respectively.

The circulating modes 78 are incident on the inner surface 86 at an angle greater than the critical angle, resulting in an evanescent field 80 emanating from the perimeter of the resonator surface 86. The evanescent field 80 may act as a probing field of species 30 to facilitate characterization of the species based upon Raman scattering induced by the evanescent field. If the cylinder has a hollow core, the inner perimeter could also be used.

Resulting Raman-shifted light may be collected by modes 78 and coupled out of the resonator 72 via the output evanescent field 40, which couples into the output optical waveguide 16. The output optical waveguide 16 carries electromagnetic signals 84 that characterize the samples 30 based on Raman scattering therefrom. The signals 84 may be analyzed, such as via the detector 20 and spectrum analyzer 26 of FIG. 1.

Note that the chemical sensor 70 is particularly adapted to characterizing fluid samples because the effective angle of incidence of the circulating modes 78 is large, which is therefore close to the critical angle associated with the silica/liquid interface 86, thereby providing for sustained TIR and efficient Raman collection into the resonator modes 78.

Hence, the resonator 72 supports whispering galley modes, having steep effective angles of incidence. The resonator 72 may be characterized by critical dimensions of many wavelengths (e.g., greater than approximately 1000 wavelengths) to enable a dense sampling of the Raman spectrum through the associated high density of resonator modes throughout the high-finesse spectral bandwidth of the resonator 72. For example, if Raman excitation is achieved using a visible or near-IR source, the corresponding resonator critical dimensions will be approximately 1 millimeter, which provides a sufficiently dense resonator mode spectrum to adequately sample and represent a typical narrow, Raman spectral feature.

Although the embodiments of FIGS. 1 and 2 employ similar operating principles as the embodiment of FIG. 3, the different designs will be typically used for different applications. For example, if the resonator material is fused silica, which is a common low-loss optical material, the nominally square design of FIG. 1 will typically be used for vapor-phase sensing, as the accompanying critical angle of approximately 43 degrees is close to the incident angle of 45 degrees, thereby providing strong evanescent-wave intensity and efficient reciprocal coupling.

For sampling bulk media such as liquids or polymers, a larger incident angle is used to sustain total internal reflection at the resonator-ambient interface. This is fulfilled by the resonator 72 of FIG. 3, where the optical modes 78 circulate at effectively steep angles of incidence along the perimeter of the resonator 72. Therefore, the nominally circular, i.e., disc-shaped design of the resonator 72 can be immersed in a liquid or polymer matrix to permit detection of chemical concentration or structural changes of bulk media.

To achieve high resonator finesse, highly reflective surface coatings can be employed. However, for dielectric resonators, ultra-high reflectivity can be achieved by using total-internal reflection, which provides very broad spectral bandwidth (>>100 nanometers) based on the slow variation with wavelength of the refractive index for appropriate low-loss optical dielectrics, such as SiO₂ or Al₂O₃. The use of reflecting mirrors may also enable coupling of light into and out of the resonator 72 by photon tunneling in which an evanescent wave tunnels across a small gap and continues propagation in the adjacent medium.

When photon tunneling is employed to excite modes of a resonator, the result is a gap-width-dependent finesse and coupling efficiency. In particular, by the principle of optical reciprocity, the input coupling efficiency also corresponds to the output coupling efficiency, which contributes to the resonator optical loss, permitting the finesse to be continuously tuned by varying the tunneling gaps. When the optical loss associated with coupling equals the sum of other losses in the resonator, the impedance-matched condition is reached, where transmission through the resonator 72 precisely on resonance is near unity, providing high signal throughput. The use of photon tunneling often requires the close positioning of two macroscopic optical surfaces, which can place strict demands on the flatness of the optical surfaces involved and be complicated by the presence of dust, and so on.

However, the gap width under impedance-matched conditions increases with increasing finesse and is typically one wavelength or more at moderate finesse, which is sufficiently large to enable the two macroscopic optical elements to be closely positioned with relative ease. Beyond the impedance-matched gap-width, the finesse continues to increase, approaching the uncoupled limit, although energy throughput on-resonance is correspondingly reduced.

The evanescent fields associated with the TIR-confined modes of a dielectric resonator also have other beneficial properties. In particular, evanescent electric fields can be employed for chemical detection as demonstrated via resonator-enhanced absorption measurements and extensive evanescent wave spectroscopy studies.

The evanescent field 80 is localized to the TIR surface 86, which permits selective detection of species located at the surface or in close proximity thereto, while providing discrimination against signals originating from the ambient bulk media. The electric field of the evanescent waves 80 is also enhanced at the TIR surface 86 by a factor between approximately 2 and 100 relative to the incident intensity (i.e., intensity of the modes 78), depending on the refractive index discontinuity and incident angle. This enhances spectroscopic detection sensitivity. Importantly, the enhancement factor associated with TIR and the enhancement factor derived from the resonator finesse are multiplicative.

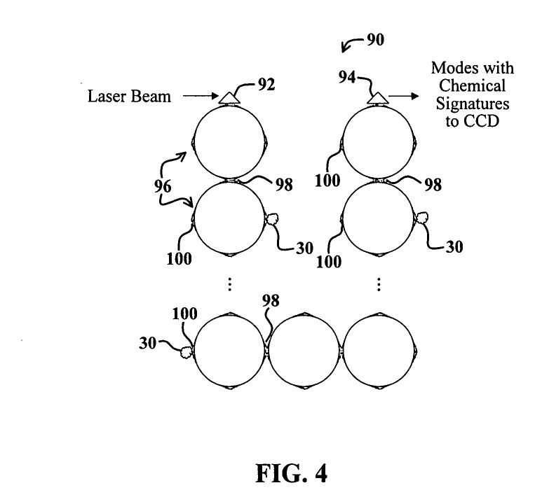

FIG. 4 is a diagram of an array 90 of chemical sensors 96 according to a fourth example embodiment. The chemical sensors 96 are implemented as resonators, which are inter-coupled via photon tunneling at gaps 98. The coupling gaps 98 may be filled with air, a liquid, or a solid.

An input prism 92 couples laser light into the resonators 96. In the present embodiment, each of the resonators 96 are coupled linearly to two adjacent resonators. Input laser energy coupled into the resonators via the first prism 92 propagates among all the resonators 96, resulting in evanescent hot spots 100 for probing the ambient medium, represented by the species 30. Chemical detection can also occur in the gaps 98 where evanescent waves exist but are also involved in coupling between the resonators 96. An output signal is coupled out of the last resonator 96 via an output prism 94.

Use of a detector array, such as the array 90, may facilitate an increase in the active sensor area, i.e., detection area corresponding to the sum of the hot spot areas 100 plus areas 98, which can improve species characterization. For example, a given chemical in a material sample, such as a gas sample, may have a partial pressure corresponding to the number of collisions of the given chemical on the hot spot 100 within a given time interval. The larger the sum of the areas of the hot spots 100, the more likely that very small concentrations of chemicals can be detected. Furthermore, chemical concentration may be determinable with more accuracy or measurement resolution.

While the array 90 is shown implemented via substantially disc-shaped resonators 96, other types of resonators, such as substantially cubic, spherical, hollow cylindrical, or toroidal dielectric resonators may be employed.

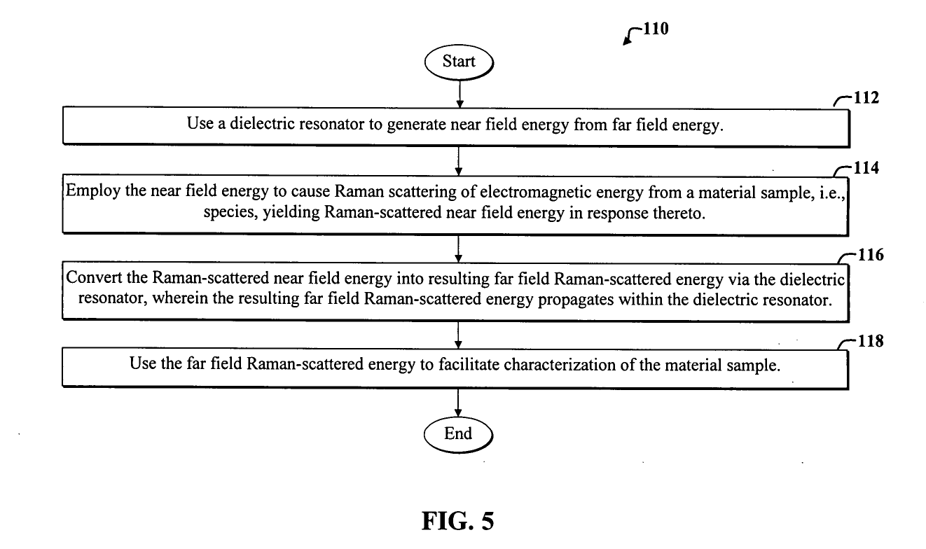

FIG. 5 is a flow diagram of a method 110 adapted for use with the chemical sensors 10, 50, 70 of FIGS. 1-4. The method 110 includes a first step 112, which includes using a dielectric resonator to generate near field energy from far field energy, where the far field energy originates from an excitation source, such as a laser, and then is coupled into far field resonator modes. The source field excites one or more modes propagating within the resonator. Near field energy may correspond to evanescent electromagnetic energy occurring at TIR surfaces of the resonator when the modes propagating therein are incident upon the surfaces at an angle greater than the critical angle.

A second step 114 includes employing the near field energy to cause Raman scattering of electromagnetic energy from a material sample, which yields Raman-scattered near field energy in response thereto.

A third step 116 includes converting the Raman-scattered near field energy into far field energy, called far field Raman-scattered energy herein, wherein the resulting Raman-scattered energy propagates within the dielectric resonator as far field modes supported thereby.

In a fourth step 118, the Raman-scattered energy circulating in the resonator modes is extracted to facilitate characterization of the material sample. In this case, the extracted Raman-scattered energy may correspond to Raman-shifted far field modes propagating in the dielectric resonator. The Raman-shifted far field modes are coupled out of the dielectric resonator via photon tunneling across an impedance-matched gap width to an output coupling optic and then transported to a spectrometer for detection.

While various embodiments have been discussed herein with respect to use of dielectric resonators and evanescent fields to initiate Raman scattering from a sample and to collect the resulting Raman signal, embodiments of the present invention are not limited thereto. For example, certain embodiments disclosed herein may be used to analyze other types of spectral phenomena, such as multi-photon absorption, emission spectra, or nonlinear optical processes, without departing from the scope of the present teachings.

Exact materials and dimensions of various components employed to implement embodiments discussed herein are application specific. Those skilled in the art with access to the present teachings may readily employ desired materials to meet the needs of a given application.

Although the invention has been discussed with respect to specific embodiments thereof, these embodiments are merely illustrative, and not restrictive, of the invention. In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances, some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

Accordingly,

What is claimed is:

1. A chemical detector comprising:
a dielectric resonator;
a source of coherent electromagnetic energy coupled to the dielectric resonator so that one or more modes of electromagnetic energy propagate within the dielectric resonator and yield an evanescent field in proximity to one or more boundaries of the dielectric resonator; and
a species to be analyzed positioned in proximity to the one or more boundaries to enable the evanescent field to cause scattering of electromagnetic energy from said species and to enable coupling of resulting scattered electromagnetic energy to one or more modes propagating within said dielectric resonator.

2. The chemical sensor of claim 1 wherein the species is positioned adjacent to an exterior surface of the dielectric resonator.

3. The chemical sensor of claim 1 wherein the source of coherent electromagnetic energy includes a laser.

4. The chemical sensor of claim 1 wherein the scattered electromagnetic energy includes Raman-scattered electromagnetic energy.

5. The chemical sensor of claim 1 wherein the species is positioned within the evanescent field to enable double resonance, wherein Raman-scattered electromagnetic energy results from incident evanescent electromagnetic energy, and wherein the resulting Raman-scattered electromagnetic energy is coupled back in to the dielectric resonator via the one or more modes propagating within the dielectric resonator.

6. The chemical sensor of claim 5 wherein one or more modes propagating within the dielectric resonator are substantially confined by total internal reflection by one or more sidewalls of the dielectric resonator.

7. The chemical sensor of claim 5 wherein the dielectric resonator is dimensioned to ensure that plural modes propagate within the dielectric resonator, wherein the plural modes are chosen to increase the probability that Raman-scattered electromagnetic energy will couple to one or more of the plural modes propagating within the dielectric resonator.

8. The chemical sensor of claim 7 wherein plural modes propagating with in the dielectric resonator are selected to optimize a photon density of states to maximize coupling of Raman-scattered electromagnetic energy to modes propagating within the dielectric resonator.

9. The chemical sensor of claim 7 wherein the dielectric resonator represents a high-finesse cavity with narrow cavity modes.

10. The chemical sensor of claim 1 further including an input coupling optic positioned in proximity to a first sidewall of the dielectric resonator so that an evanescent field emanating from said input coupling optic couples into said cavity resonator via photon tunneling.

11. The chemical sensor of claim 10 wherein said coupling optic includes an optical waveguide.

12. The chemical sensor of claim 10 wherein said coupling optic includes a prism.

13. The chemical sensor of claim 10 wherein said coupling optic is spaced relative to the first sidewall to create a gap therebetween, wherein a space between said coupling optic and said first sidewall represents a gap width that satisfies or approximately satisfies an impedance-matched condition.

14. The chemical sensor of claim 13 wherein the impedance-matched condition includes a condition wherein energy loss associated with a group of photons tunneling across the gap approximately equals the energy loss associated with the group of photons traversing the dielectric resonator.

15. The chemical sensor of claim 13 wherein the gap width is approximately a wavelength of the electromagnetic energy or larger.

16. The chemical sensor of claim 13 wherein said dielectric resonator is characterized by a tunable finesse, wherein said finesse can be tuned by adjusting the gap width.

17. The chemical sensor of claim 1 wherein a dimension of the dielectric resonator is larger than approximately 1000 times a wavelength of the electromagnetic energy.

18. The chemical sensor of claim 1 wherein the dielectric resonator is substantially disc shaped.

19. The chemical sensor of claim 1 wherein the dielectric resonator has an approximately square or rectangular cross-section, and wherein one or more sides of the approximately square or rectangular cross-section are curved.

20. A method for characterizing a species comprising:
using a dielectric resonator to generate near field energy from far field energy;
employing the near field energy to cause Raman scattering of electromagnetic energy from the species, yielding Raman-scattered near field energy in response thereto;
converting the Raman-scattered near field energy into far field Raman-scattered energy propagating within the dielectric resonator; and
using the far field Raman-scattered energy to characterize the species.

21. A chemical detector comprising:
a dielectric cavity;
a species to be detected, wherein the species is positioned near a surface of the dielectric cavity so that evanescent electromagnetic energy emanating from the surface causes Raman scattering from the species; and
modes propagating within the cavity, wherein the modes are adapted to yield said evanescent electromagnetic energy and to couple Raman-scattered electromagnetic energy back into one or more of the modes.

22. The chemical sensor of claim 21 wherein the dielectric cavity represents a stable optical resonator.

23. The chemical sensor of claim 21 further including an input coupling optic for coupling input electromagnetic energy into the dielectric cavity via photon tunneling across a gap between the input coupling optic and the dielectric cavity.

24. The chemical sensor of claim 23 wherein a distance across the gap is approximately one wavelength or larger, wherein the wavelength corresponds to the wavelength of the input electromagnetic energy.

25. The chemical sensor of claim 21 further including an output coupling optic adapted to couple one or more modes within the dielectric cavity that contain electromagnetic energy corresponding to the Raman-scattered electromagnetic energy, and to provide an output signal in response thereto.

26. A chemical detector comprising:
a stable dielectric resonator;
coherent electromagnetic energy propagating within the stable dielectric resonator via one or more modes, wherein the stable dielectric resonator is characterized by one or more dimensions greater than approximately 1000 times a wavelength of the coherent electromagnetic energy;
a substance to be analyzed positioned in proximity to a surface of the stable dielectric resonator so that electromagnetic energy corresponding to the one or modes scatters from the species, resulting in scattered electromagnetic energy propagating within the stable dielectric resonator; and
an output device coupled to the stable dielectric resonator, wherein the output device is adapted to output energy corresponding to the scattered electromagnetic energy.

27. The chemical sensor of claim 26 wherein the electromagnetic energy corresponding to the one or more modes includes an evanescent wave.

28. The chemical sensor of claim 27 wherein the resulting scattered electromagnetic energy includes Raman-scattered energy resulting from scattering of the evanescent wave.
